(19) United States
(12) Patent Application Publication
(10) Pub. No.: US 2018/0260772 A1
(43) Pub. Date: Sep. 13, 2018

(54) OUT-OF-STOCK DETECTION BASED ON IMAGES

(71) Applicant: Focal Systems, Inc, Millbrae, CA (US)

(72) Inventors: Francois Chaubard, Millbrae, CA (US); Adriano Quiroga Garafulic, Sao Paulo (BR)

(21) Appl. No.: 15/973,497

(22) Filed: May 7, 2018

Related U.S. Application Data
(63) Continuation-in-part of application No. 15/885,744, filed on Jan. 31, 2018.
(60) Provisional application No. 62/452,882, filed on Jan. 31, 2017.
(60) Provisional application No. 62/503,206, filed on May 8, 2017.

(51) Int. Cl. G06Q 10/08; G06T 7/00; H04N 7/18

(52) U.S. Cl. CPC G06Q 10/087; G06T 7/0008; G06T 2207/20081; G06T 2207/30108; H04N 7/181

(57) ABSTRACT

An out-of-stock detection system notifies store management that a product is out of stock. The out-of-stock detection system collects image data from shopper client devices that are attached to an in-store vehicle. The shopper client devices include one or more cameras that capture images of the store as the shoppers travel through the store. The out-of-stock detection system detects products, voids, and price tags in the image data and determines whether any products are out of stock based on the information detected in the image. For example, the out-of-stock detection system may detect a void on the shelf, and will then look at the price tag underneath the void to see what should have been there, and determine that that product is out of stock. Upon identifying an item as out-of-stock, the out-of-stock detection system notifies the store management that the item is out of stock.

### CROSS REFERENCE TO RELATED APPLICATION

This application claims the benefit of U.S. Provisional Patent Application No. 62/503,206, filed on May 8, 2017, the contents of which are hereby incorporated by reference in their entirety. This application is additionally a continuation-in-part application of U.S. patent application Ser. No. 15/885,744, filed on Jan. 31, 2018, which claims to the benefit of U.S. Provisional Patent Application No. 62/452,882, filed on Jan. 31, 2017, the contents of each of which are hereby incorporated by reference in their entirety.

### BACKGROUND

Stores offer items for sale to shoppers who visit the stores. As shoppers purchase the items that are available for sale, store management continually must restock the items so that shoppers can continue to purchase them. However, different items may need to be restocked at different rates and the rates at which items need to be restocked may change over time, and thus the store management needs up-to-date information on whether items need to be restocked. Typically, in order to receive the up-to-date information, an employee of the store regularly traverses the store and identifies items that need to be restocked. However, this method requires significant amounts of employee-hours during the operation of the store. While the store management can reduce the regularity with which an employee traverses the store, this would come at the cost of items remaining out of stock for greater periods of time during which shoppers cannot purchase the items. Thus, store management needs to balance employee time with restocking items, which itself requires resources from the store management. Thus, conventional methods for identifying out of stock items requires significant resources from stores, thus increasing the stores' expenses.

### SUMMARY

An out-of-stock detection system notifies store management that a product is out of stock. The out-of-stock detection system collects image data from shopper client devices that are attached to shopping carts or hand-held baskets being used by shoppers in the store. The shopper client devices include one or more cameras that capture images of the store as the shoppers travel through the store. The out-of-stock detection system detects products in the image data and determines whether any products are out of stock based on the products that are detected. For example, the out-of-stock detection system may determine which products should be detected in the image data and identify as out of stocks the products that are not actually detected in the image data. Upon identifying an item as out-of-stock, the out-of-stock detection system notifies the store management that the item is out of stock. In some embodiments, the out-of-stock detection system generates a bounding box illustrating where the out-of-stock item should be in the image data and presents the bounding box to the store management.

In some embodiments, the out-of-stock detection system detects out-of-stock items by generating bounding boxes that identify empty portions of shelves or display areas within the stores. These bounding boxes identify areas where a product is out of stock, but may not yet identify which product is out of stock. These bounding boxes may be associated with price tags near the bounding boxes, thereby allowing the out-of-stock detection system to identify the product associated with the bounding box based on information extracted from the price tag. Thus, the out-of-stock detection system can identify the out-of-stock products associated with the bounding boxes identifying empty portions of shelves or display areas.

An out-of-stock detection system as described herein allows a store's management to have up-to-date information on which items are out of stock within the store, so items can be restocked more quickly. It also removes the need for a store employee to travel through the store to determine which items are out of stock, thereby reducing the number of employee-hours that the store spends on restocking items. Furthermore, the out-of-stock detection system can collect and analyze data on the rate at which items need to be restocked and can present the analyzed data to the store management for more information on how often items need to be restocked.

### BRIEF DESCRIPTION OF THE DRAWINGS

FIG. 1 illustrates an example system environment and architecture for an out-of-stock detection system, in accordance with some embodiments.

FIG. 2 illustrates an example image received from the shopper client device that is presented to the store associate via the store client device 200, in accordance with some embodiments.

FIG. 3 is a flowchart for an example method for detecting out-of-stock items within a store, in accordance with some embodiments.

FIG. 4 is a flowchart for a method of detecting out-of-stock items based on images captured by the shopper client device, in accordance with some embodiments.

### DETAILED DESCRIPTION

### Example System Environment and Architecture

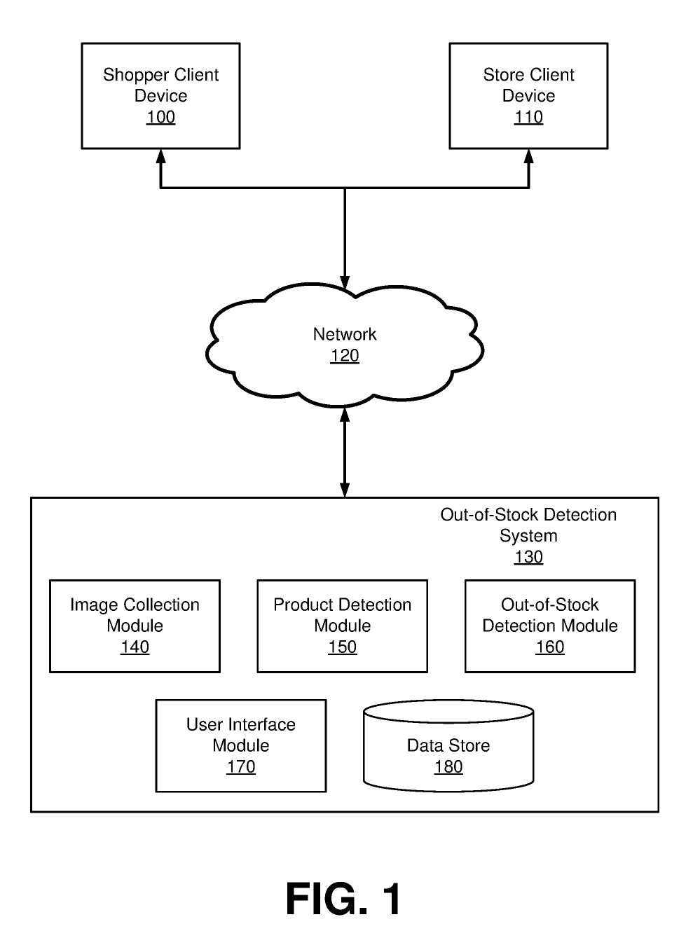

An out-of-stock detection system uses image data from shopper client devices to identify items that are out of stock within a store. FIG. 1 illustrates a system environment for an out-of-stock detection system, in accordance with some embodiments. FIG. 1 includes a shopper client device 100, a store client device 110, a network 120, and an out-of-stock detection system 130. Alternate embodiments may include more, fewer, or different components and the functionality of the illustrated components may be divided between the components differently from how it is described below. For example, while only one shopper client device 100 and store client device 110 is illustrated, alternate embodiments may include multiple shopper client devices 100 and store client devices 110. Additionally, the functionality of the store client device 110 may be performed by one or more store client devices 110.

The shopper client device 100 collects information required by the out-of-stock detection system 130 to determine whether items around the shopper are out of stock. In some embodiments, the shopper client device 100 is a personal or mobile computing device, such as a smartphone, a tablet, a laptop computer, or a desktop computer. Alternatively, the shopper client device 100 can contain specialized hardware for performing the functionality described herein. In some embodiments, the shopper client device 100 can execute a client application for the out-of-stock detection system 130. For example, if the shopper client device 100 is a mobile device, the shopper client device 100 may execute a client application that is configured to communicate with the out-of-stock detection system 130.

The shopper client device 100 is attached to a shopping unit that the shopper uses to hold products that the shopper intends to purchase from the store. For example, the shopper client device 100 may be attached to a hand-held shopping basket or a shopping cart. The shopper client device 100 may be temporarily attached to the shopping unit (e.g., by holding the shopper client device 100 in a mount) or may be permanently attached to the shopping unit (e.g., via a bracket, a strap, screws, bolts, or an adhesive).

The shopper client device 100 can include one or more cameras that are used to capture images of products that are physically located near the shopper. The shopper client device 100 may be attached to the shopping unit such that the camera is directed toward shelves of the store as a shopper traverses through the store. For example, if the shopper client device 100 is a mobile device, the shopper client device 100 may be held in a mount such that the camera of the shopper client device 100 is directed toward the store shelves as the shopper traverses through the store. In some embodiments, the shopper client device 100 is connected to one or more cameras that are mounted to the shopper unit and that capture images around the shopping unit. The camera may capture images on regular time intervals or in response to determining that the shopper has moved within the store. In some embodiments, the shopper client device 100 collects additional information used by the out-of-stock detection system 130 to identify items that are out of stock. For example, the shopper client device 100 can collect motion data (e.g. from an accelerometer) to infer when the shopper is moving around the store. The shopper client device 100 may also send information about the shopper client device 100 to the out-of-stock detection system 130, such as a unique device ID, battery level, external battery connection, IP address, software version number, or whether the device is moving within the store. The shopper client device 100 may also send information about a shopper's trip through the store, such as the number times the shopper interacts with the shopper client device 100, the time the shopper spends in the store, and the products the shopper searches for or interacts with through the shopper client device 100.

The store client device 110 receives information about the status of the store from the out-of-stock detection system 130 and presents the information to a store associate (e.g., a store owner, manager, or employee). For example, the store client device 110 may present a store associate with information about which items are out of stock and when the items were first detected to be out of stock. The store client device 110 may also present a map that indicates where, in the store, out-of-stock items are located. In some embodiments, the store client device 110 presents images within which the out-of-stock detection system 130 has detected out-of-stock items. These images may include bounding boxes that identify where in the image an out-of-stock item is located.

A store associate can also use the store client device 110 to capture reference images of the store for the out-of-stock detection system 130. Reference images are images of products on shelves within the store for training the out-of-stock detection system 130. The reference images are labeled with bounding boxes via a human manually or a deep learning computer vision algorithm that identify portions of the reference images that represent identified items on the shelf, price tags on the shelf with parsed out information such as price, stock keeping unit, and any other data that is within the price tag, and voids where products should be. The reference images may include high-resolution images or low-resolution images captured by one or more high-resolution cameras or low-resolution cameras, respectively, of the store client device 110. One or more of the reference images may also include images taken with a wide-angle lens.

In some embodiments, a set of reference images are captured using a camera that is different or the same as the camera that is used by the shopper client device 100. Each of these reference images may be associated with one or more higher-resolution reference images that capture an area that overlaps with the lower-resolution reference image. The lower-resolution image and the higher-resolution images may be used in combination to train a model for detecting out-of-stock items by the out-of-stock detection system 130, as described below.

The shopper client device 100 and the store client device 110 can communicate with the out-of-stock detection system 130 via the network 120, which may comprise any combination of local area and wide area networks employing wired or wireless communication links. In one embodiment, the network 120 uses standard communications technologies and protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any format, such as hypertext markup language (HTML) or extensible markup language (XML). In some embodiments, all or some of the communication links of the network 120 may be encrypted.

The out-of-stock detection system 130 detects out-of-stock items within the store based on images received from the shopper client device 100. The out-of-stock detection system 130 may be located within the store or remotely. FIG. 1 illustrates an example system architecture of an out-of-stock detection system 130, in accordance with some embodiments. The out-of-stock detection system 130 illustrated in FIG. 1 includes an image collection module 140, a product detection module 150, an out-of-stock detection module 160, a user interface module 170, and a data store 180. Alternate embodiments may include more, fewer, or different components from those illustrated in FIG. 1, and the functionality of each component may be divided between the components differently from the description below. Additionally, each component may perform their respective functionalities in response to a request from a human, or automatically without human intervention.

The image collection module 140 collects images from the shopper client device 100 and the store client device 110. If the received image is a reference image, the image collection module 140 may also collect image labeling data that labels the items displayed in the reference image. The image collection module 140 stores collected images and image labeling data in the data store 190. In some embodiments, the image collection module 140 filters out unsatisfactory reference images received from the store client device 110. For example, if a reference image is blurry, out of focus, or over- or under-exposed, if the image does not show a sufficient portion of the shelf, or if the image contains a person or personally identifiable information, the image collection module 140 may reject the reference image. If the rejected image is a reference image, the image collection module 140 can prompt the store associate to retake the rejected image using the store client device 110.

The product detection module 150 detects products in images captured by the shopper client device 100 or the store client device 110. For each product detected in the images, the product-detection module 150 can identify a location on the shelves of the detected product and a likelihood that the product prediction is accurate. In some embodiments, the product detection module 150 detects products within the images by requesting that the shopper or the store associate identify the products in the images using the shopper client device 100 or the store client device 110. Alternatively, the product detection module 150 can identify products in the received images automatically. For example, the product detection module 150 may apply an optical character recognition (OCR) algorithm to the received images to identify text in the images, and may determine which products are captured in the image based on the text (e.g., based on whether the text names a product or a brand associated with the product). The product detection module 150 also may use a barcode detection algorithm to detect barcodes within the images and identify the products based on the barcodes. For example, store shelves may display a price tag that contains a barcode, or written numerical values that represent the stock keeping unit, for each product on the shelves, and the product detection module 150 may identify the product above each price tag as the product associated with the barcode or stock keeping unit.

In some embodiments, the product detection module 150 uses a machine-learned product-detection model to detect the products in the images. The product-detection model can be trained based on reference images that have been labeled by the store associate. In some embodiments, the product-detection model is trained based on labeled images of the products offered for sale by the store. The product-detection model identifies the products in the images and where those products are located on the shelves. In some embodiments, the product-detection model generates bounding boxes for each product and determines a likelihood that the product-detection model's prediction is correct. The product-detection model can be a convolutional neural network that has been trained using labeled training data via Stochastic Gradient Descent based on the references images.

The product detection module 150 can use the product-detection model to compare images received from the shopper client device 100 to reference images captured by the store client device 110. In some embodiments, the product detection module 150 receives multiple images from the shopper client device 100 that were captured at the same time and that together capture a contiguous portion of the store. The product detection module 150 may compare the multiple images from the shopper client device 100 to higher-resolution reference images to detect the products in the images received from the shopper client device 100. Similarly, the product detection module 150 may compare the multiple images to a set of associated reference images that together capture an area of the store similar to the multiple images received from the shopper client device 100.

In some embodiments, the images received from the shopper client device 100 are taken using a wide-angle lens. The product detection module 150 can compare a received wide-angle image to sets of associated reference images that capture an area of the store that is similar to the area captured by the image received from the shopper client device 100. The set of associated reference images can include a labeled, wide-angle reference image and one or more additional reference images that capture a similar area of the store to the wide-angle reference image. The product detection module 150 can use the set of associated reference images to detect products in the wide-angle images received from the shopper client device 100.

In some embodiments, the product detection module 150 detects empty portions of shelves or display areas within the store. The product detection module 150 can generate bounding boxes that identify portions of images received from the shopper client device 100 where a product is out of stock. While the bounding boxes may identify portions of images where a product is out of stock, the bounding boxes may not actually identify which product is out of stock. The bounding boxes may be generated using a machine-learned model that is trained based on reference images of empty shelves or display areas within the store. The machine-learned model may also be trained based on reference images with one or more stocked products as well.

The out-of-stock detection module 160 detects out-of-stock items in images received from the shopper client device 100. The out-of-stock detection module 160 uses products detected by the product detection module 150 to detect out-of-stock items in the received images. For example, the out-of-stock detection module 160 may use the reference images to determine which products are supposed to be detected in an image receive from a shopper client device 100. The out-of-stock detection module 160 may determine which products are supposed to be detected in the image by identifying one or more reference images that capture areas of the store that are captured by the received images. If the out-of-stock detection module 160 determines that an item is not detected in the image received from the shopper client device 100 that is supposed to be detected in the image, the out-of-stock detection module 160 determines that the item is out of stock.

In some embodiments, the out-of-stock detection module 160 uses price tags on shelves to determine if an item is out of stock. The out-of-stock detection module 160 can detect price tags bounding boxes in the images received from the shopper client device 100 and can extract information from each price tag like the barcode, the stock keeping unit, the price, the sale price if it is on sale, the name of the product, and any other visual information that is on the price tag. For example, the out-of-stock detection module 160 may extract the name of a product, stock keeping unit, or a barcode from the price tag and the out-of-stock detection module 160 may determine that the products identified by the price tags should be detected in the image received from the shopper client device 100 near that price tag. If the out-of-stock detection module 160 does not detect the items identified by the price tag near (e.g., immediately above or below) that tag, the out-of-stock detection module 160 determines that the items are out of stock.

In some embodiments, the out-of-stock detection module 160 uses a planogram detect out of stock items. The out-of-stock detection module 160 may compare images received from the shopper client device 100 to reference images of the store to determine the shopper's location in the store. The reference images may be associated with location information and the out-of-stock detection module 160 can use the location information from the reference images to determine the location of the shopper. The out-of-stock detection module 160 may then compare the shopper's location to a planogram to determine which products should be near the shopper. If a product that should be near the shopper is not detected in an image from the shopper client device, the out-of-stock detection module 160 determines that the product is out of stock or if it is detected but not near the price tag, we would determine that the item is not out of stock, but is stocked incorrectly.

In some embodiments, the out-of-stock detection module 160 compares bounding boxes identifying empty shelves or display areas to information from identified price tags to identify out-of-stock items. The out-of-stock detection module 160 may use a machine-learned model to identify the locations of price tags within images received from the shopper client device 100. The out-of-stock detection module 160 may then use an optical character recognition (OCR) algorithm to extract information from a price tag that describes the product. For example, the out-of-stock detection module 160 may extract the name of the product, a product identifier (e.g., the stock keeping unit or the universal product code for the product), or the price of the product from the price tag. The out-of-stock detection module 160 can then associate price tags with empty portions of the store by comparing the location of the bounding boxes identifying empty shelves or display areas to the locations of identified price tags to identify which price tags correspond to the bounding boxes. In some embodiments, the out-of-stock detection module 160 associates each bounding box identifying empty shelves or display areas with the closest identified price tag. After associating the bounding boxes with the price tags, the out-of-stock detection system can identify the products that are out of stock within each bounding box based on the information extracted from the price tags.

When the out-of-stock detection module 160 determines that an item is out of stock, the out-of-stock detection module 160 notifies the store client device 110 that the item is out of stock. The out-of-stock detection module 160 may transmit an item identifier for the out-of-stock item as well as a timestamp of when the item was detected as being out of stock. In some embodiments, the out-of-stock detection module 160 generates a bounding box that describes where the out-of-stock item would be in the image received from the shopper client device 100. The out-of-stock detection module 160 transmits the image with the bounding box to the store client device 110 for presentation to the store associate.

The user interface module 170 interfaces with the shopper client device 100 and the store client device 110. The interface generation module 170 may receive and route messages between the out-of-stock detection system 130, the shopper client device 100, and the store client device 110, for example, instant messages, queued messages (e.g., email), text messages, or short message service (SMS) messages. The user interface module 170 may provide application programming interface (API) functionality to send data directly to native client device operating systems, such as IOS®, ANDROID™, WEBOS®, or RIM®.

The user interface module 170 generates user interfaces, such as web pages, for the out-of-stock system 130. The user interfaces are displayed to the shopper or the store associate through a shopper client device 100 or the store client device 110, respectively. The user interface module 170 configures a user interface based on the device used to present it. For example, a user interface for a smartphone with a touchscreen may be configured differently from a user interface for a web browser on a computer.

The user interface module 170 can provide a user interface to the store client device 110 for capturing reference images of store shelves that hold products for sale by the store. Additionally, the user interface module 170 may provide a user interface to the store client device 110 for labeling products in reference images. The user interface module 170 receives images from the shopper client device 100 and the store client device 110 and stores the images in the data store 180.

The data store 180 stores data used by the out-of-stock detection system 130. For example, the data store 180 can store images from the shopper client device 100 and the store client device 110. The data store 180 can also store location information associated with reference images, and can store products identified in images by the product detection module 150. The data store 180 can also store product information, a store map or planogram, shopper information, or shopper location information. In some embodiments, the data store 180 also stores product-detection models or other machine-learned models generated by the out-of-stock detection system 130.

### Example Image From Shopper Client Device

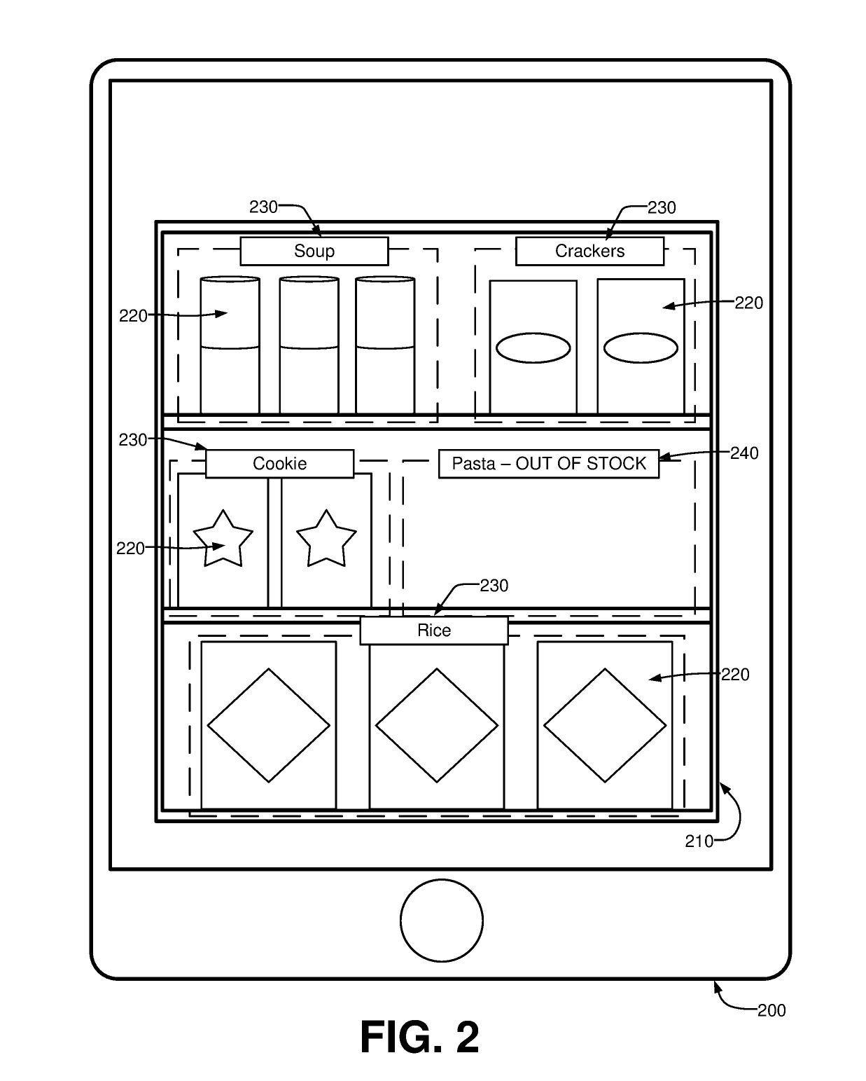

FIG. 2 illustrates an example image received from the shopper client device that is presented to the store associate via the store client device 200, in accordance with some embodiments. The received image was captured by a camera of the shopper client device and describes shelves 210 with products 220 that are for sale by the store. The out-of-stock detection system identifies the products in the image and can present identifiers 230 for the products to the store associate. The out-of-stock detection system also detects products in the image that are out of stock and identifies the products to the store associate. For example, the out-of-stock detection system has determined that the pasta is out of stock and has presented a bounding box 240 that identifies where the pasta should be stocked.

### Example Methods for Detecting Out-of-Stock Items

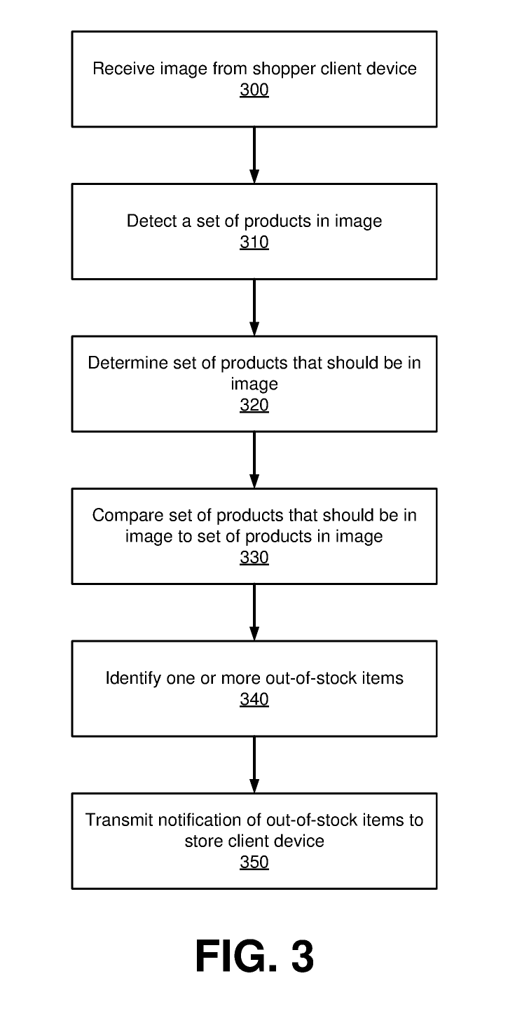

FIG. 3 is a flowchart for a method of detecting out-of-stock items based on images captured by the shopper client device, in some embodiments. Alternate embodiments may include more, fewer, or different steps from those illustrated in FIG. 3, and the steps may be performed in a different order from that illustrated in FIG. 3. Additionally, each of these steps may be performed automatically by the out-of-stock detection system without human intervention.

The out-of-stock detection system receives 300 an image data from the shopper client device. The image data can include one or more images taken by one or more cameras of the shopper client device. The out-of-stock detection system detects 310 a set of products in the image. The out-of-stock detection system may apply a product detection model to the image data to detect 310 the set of products. The out-of-stock detection system determines 320 a set of products that should be captured by the image data. The out-of-stock detection system may determine 320 the set of products that should be in the image data by comparing the products that were detected in the image data to products labeled in reference images. The out-of-stock detection system compares 330 the set of products that should be described by the image data to the set of products detected in the image data and identifies 340 one or more out-of-stock items based on the differences in the two sets of products. The out-of-stock detection system then transmits 350 a notification to a store client device that identifies the out-of-stock items.

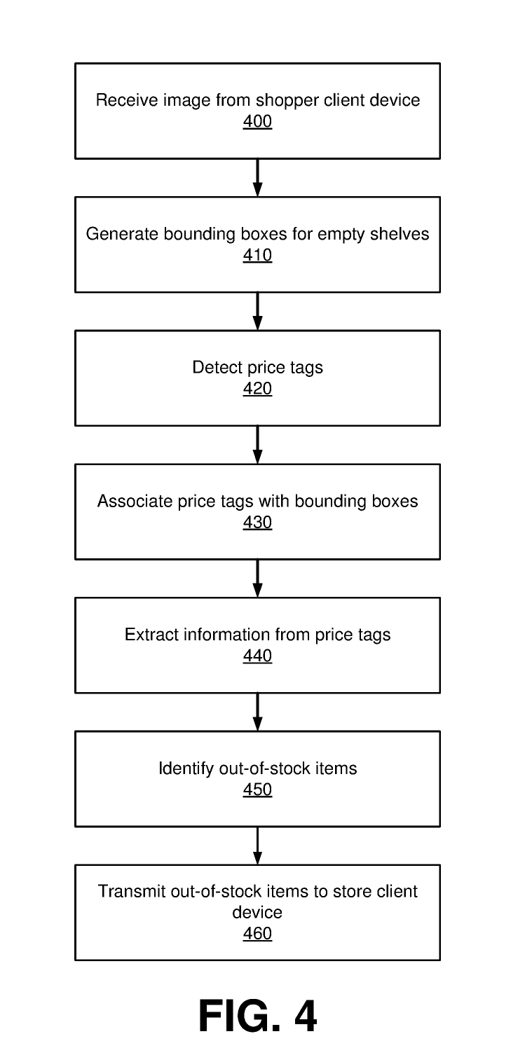

FIG. 4 is a flowchart for a method of detecting out-of-stock items based on images captured by the shopper client device, in accordance with some embodiments. Alternate embodiments may include more, fewer, or different steps from those illustrated in FIG. 3, and the steps may be performed in a different order from that illustrated in FIG. 3. Additionally, each of these steps may be performed automatically by the out-of-stock detection system without human intervention.

The out-of-stock detection system receives 400 an image data from the shopper client device. The image data can include one or more images taken by one or more cameras of the shopper client device. The out-of-stock detection system detects 410 bounding boxes that identify portions of the one or more images that empty portions of the store, such as empty shelves or display areas. Each bounding box also represents a product that is out of stock, though the out-of-stock detection system may not yet know which product is out of stock. The out-of-stock detection system detects 420 one or more price tags within the one or more images and associates 430 the price tags with the generated bounding boxes. The out-of-stock detection system can then extract 440 information from the price tags and then identify 450 out-of-stock items that correspond to the bounding boxes. The out-of-stock detection system transmits 460 the identified out-of-stock items to a store client device for presentation to a store associate.

### Additional Configurations

In some cases, shopper client devices attached to shopping carts or hand-held baskets may not provide sufficient or even coverage of the store. For example, shoppers may spend more time in some parts of the stores than others or may be more likely to move through some parts of the store than others, thereby causing some portions of the store to be less frequently reviewed by the out-of-stock detection system. Furthermore, some parts of the store may be commonly used by shoppers who do not use a shopping cart or a hand-held basket, and thus products may be out of stock without the out-of-stock detection system detecting that this is so.

To receive more thorough and consistent coverage within a store, the shopper client device may be attached to an in-store vehicle operated by store management or employees, such as a janitor's cart, a floor sweeper, a fork-lift, a shopping cart used by store management or employees to stock items in the store, or a shopping cart used by an individual who is collecting items in the shopping cart for an online order by a user of an online shopping system. The in-store vehicle may regularly travel through the store and capture image data that can be used by the out-of-stock detection system to detect out-of-stock products. The in-store vehicle may travel through the entire store or may travel to specific parts of the store (e.g., parts of the store that need to be maintained or where shoppers are unlikely to travel). The in-store vehicle may be transported through the store by an operator of the in-store vehicle or may autonomously travel through the store. By attaching the shopper client device to an in-store vehicle, the out-of-stock detection system can more effectively detect out-of-stock items within the store.

In some embodiments, the out-of-stock detection system detects out-of-stock products in the store based on images received from cameras mounted within the store. The cameras may be directed towards shelves that display products to customers within the store. The cameras may regularly transmit images to the out-of-stock detection system and thereby provide additional coverage for out-of-stock products in the store.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving image data from a client device attached to an in-store vehicle, the image data capturing an area of a store;
generating one or more bounding boxes based on the received image data, the one or more bounding boxes identifying one or more empty portions of the store;
detecting one or more price tags based on the image data;
associating each bounding box of the one or more bounding boxes with a price tag of the one or more price tag based on a location of each bounding box within the image data and a location of each price tag within the image data;
extracting product information from each price tag based on the image data, the product information from each price tag describing a product associated with the price tag;
identifying one or more out-of-stock items based on the extracted product information from each price tag of the one or more price tags and the one or more bounding boxes; and
transmitting notification of the identified one or more out-of-stock products to a store client device.

2. The method of claim 1, wherein the image data comprises a plurality of images from a plurality of cameras of the client device.

3. The method of claim 1, wherein the image data comprises a wide-angle image captured by a wide-angle camera of the client device.

4. The method of claim 1, wherein the one or more bounding boxes are generated by applying a machine-learned model to the image data.

5. The method of claim 1, wherein the one or more price tags are detected by applying a machine-learned model to the image data.

6. The method of claim 1, wherein the product information is extracted from each price tag by applying an deep learning computer vision model to the image data.

7. The method of claim 1, wherein the product information comprises at least one of a name of a product, a product identifier, or a price of a product.

8. The method of claim 1, wherein the notification comprises the one or more bounding boxes.

9. The method of claim 1, wherein each bounding box is associated with a closest price tag of the one or more price tags.

10. A non-transitory, computer-readable medium comprising instructions that, when executed by a processor, cause the processor to:
receive image data from a client device attached to an in-store vehicle, the image data capturing an area of a store;
generate one or more bounding boxes based on the received image data, the one or more bounding boxes identifying one or more empty portions of the store;
detect one or more price tags based on the image data;
associate each bounding box of the one or more bounding boxes with a price tag of the one or more price tag based on a location of each bounding box within the image data and a location of each price tag within the image data;
extract product information from each price tag based on the image data, the product information from each price tag describing a product associated with the price tag;
identify one or more out-of-stock items based on the extract product information from each price tag of the one or more price tags and the one or more bounding boxes; and
transmit notification of the identified one or more products to a store client device.

11. The computer-readable medium of claim 10, wherein the image data comprises a plurality of images from a plurality of cameras of the client device.

12. The computer-readable medium of claim 10, wherein the image data comprises a wide-angle image captured by a wide-angle camera of the client device.

13. The computer-readable medium of claim 10, wherein the one or more bounding boxes are generated by applying a machine-learned model to the image data.

14. The computer-readable medium of claim 10, wherein the one or more price tags are detected by applying a machine-learned model to the image data.

15. The computer-readable medium of claim 10, wherein the product information is extracted from each price tag by applying an optical character recognition algorithm to the image data.

16. The computer-readable medium of claim 10, wherein the product information comprises at least one of a name of a product, a product identifier, or a price of a product.

17. The computer-readable medium of claim 10, wherein the notification comprises the one or more bounding boxes.

18. The computer-readable medium of claim 10, wherein each bounding box is associated with a closest price tag of the one or more price tags.

19. A client device mounted to an in-store vehicle, the client device comprising:
one or more cameras mounted to the shopping cart and oriented to capture image data of items placed in a storage area of the shopping cart;
a processor; and
a non-transitory, computer-readable medium comprising instructions that, when executed by the processor, causes the processor to:
receive image data from a client device, the image data capturing an area of a store;
generate one or more bounding boxes based on the received image data, the one or more bounding boxes identifying one or more empty portions of the store;
detect one or more price tags based on the image data;
associate each bounding box of the one or more bounding boxes with a price tag of the one or more price tag based on a location of each bounding box within the image data and a location of each price tag within the image data;
extract product information from each price tag based on the image data, the product information from each price tag describing a product associated with the price tag;
identify one or more out-of-stock items based on the extracted product information from each price tag of the one or more price tags and the one or more bounding boxes; and
transmit notification of the identified one or more out-of-stock products to a store client device.

20. The client device of claim 19, wherein the product information is extracted from each price tag by applying an optical character recognition algorithm to the image data.
